(19) United States
(12) Patent Application Publication
(10) Pub. No.: US 2022/0289963 A1
(43) Pub. Date: Sep. 15, 2022

(54) POLYMER FORMULATION FOR AGRICHEMICAL USE

(71) Applicant: Adjuvants Unlimited, LLC, Tulsa, OK (US)

(72) Inventors: Amy CARTER, (US); Rick SMITH, (US); Mike POMPEO, (US); Mickey BRIGANCE, (US); Kevin CROSBY, (US)

(21) Appl. No.: 17/694,114

(22) Filed: Mar. 14, 2022

Related U.S. Application Data
(60) Provisional application No. 63/160,683, filed on Mar. 12, 2021.

(51) Int. Cl. C08L 33/26; A01N 25/10; A01N 25/12; A01N 37/10

(52) U.S. Cl. CPC C08L 33/26; A01N 25/10; A01N 25/12; A01N 37/10

(57) ABSTRACT

A composition including a salt of a monocarboxylic acid, and a polyacrylamide polymer that hydrates at a pH of at least approximately 6 in the presence of no more than approximately 40 wt % of the salt of a monocarboxylic acid. The present disclosure also includes a method for producing a homogeneous composition for agrichemical use including the following steps. Obtaining a salt of a monocarboxylic acid. Obtaining a polyacrylamide polymer that hydrolyzes in the presence of no more than 40 wt % (or 30 wt %) of the salt of a monocarboxylic acid at a pH of at least about 6. Combining the polyacrylamide and the monocarboxylic acid salt to produce a homogeneous composition. The polymer of the composition is preferably compatible and stable with formulations of potassium glyphosate and used in a spray mixture. The composition may also contain formulation components such a defoamers, water conditioners, surfactants, biocides, stickers and solvents.

### CROSS REFERENCE TO RELATED APPLICATION

This application claims the benefit of U.S. Provisional Application No. 63/160,683 entitled IMPROVED POLYMER FORMULATIONS FOR AGRICHEMICAL USE, filed Mar. 12, 2021, herein incorporated by reference in its entirety for all purposes

### FIELD OF THE DISCLOSURE

The present disclosure relates, generally, to compositions of polymers and anti-volatility additives with commercially acceptable physical characteristics for agrichemical use.

### BACKGROUND OF THE INVENTION

Use of highly active herbicides can lead to environmental impacts due to “off-site” movement onto non-target crops or environmentally sensitive non crop areas such as wetlands, wildlife refuges, roadsides or residential areas resulting in observable, unintended phytotoxicity to plants. Off-site movement can particularly threaten endangered species that occur in these non-crop areas.

Additionally, non-observable effects on animal species can occur from offsite movement, including human health effects.

There are at least two potential mechanisms for offsite movement of herbicides and pesticides. The first is the well documented phenomena of pesticide drift which is a result of fine pesticide spray particles (generally less than 141 microns in size) generated by hydraulic spray nozzles. Typically pesticides are diluted in water and sprayed under pressure through hydraulic nozzles. If there is wind during spraying, these fine particles can travel considerable distances (ref) out of the intended crop area onto non-target plants. This phenomena has been observed for many pesticides and has been the cause of injury for a wide variety of organisms both plant and animal.

Drift has been recognized as a standard phenomenon from hydraulic spraying and several technologies to reduce drift have introduced, including

The second mechanism for offsite movement is vapor phase transport of the pesticides from the point of application. Some pesticides (eg dicamba) have known potential for volatility from the post of application and subsequent vapor phase transfer to offsite plants. The effects of volatility can be reduced by a variety of means, including altering the physical form of the pesticide (salt versus ester for example), formulation additives, control of spray pH and strict controls on the timing of and environmental conditions during spraying. US

Thus with highly active and potentially volatile herbicides such as dicamba control of drift and volatility are highly desirable for proper application and environmental protection.

Control of caused by fine particles has been demonstrated for pesticide sprays by the use of polymeric additives to spray mixtures such as guar and guar derivatives (U.S. Pat. Nos. 5,874,096, 5,906,962) and polyacrylamides (U.S. Pat. Nos. 6,288,010, 6,423,109).

U.S. Pat. No. 6,288,010 details the use of an anionic polyacrylamide combined with a water soluble additive such as ammonium sulfate to counteract hard water cations which can interfere with pesticide activity.

Polyacrylamides are made by a process of polymerization of acrylamide monomer followed by selective hydrolysis to product anionic groups. The degree on anionic charges can range from over 50% to less than 10%. This gives various physical properties to polymers of different anionic charge density.

An important distinction must be made within the class of polyacrylamides, in that not all polyacrylamides are useful in all agricultural spray mixes. Mostly anionic polyacrylamides can be incompatible with pesticides that have surfactants with a cationic character. For example the anionic polyacrylamides detailed in U.S. Pat. No. 6,288,010 precipitate out of solution when added to a solution of potassium glyphosate (commercial example: Roundup Powermax® manufactured by Bayer). The resulting precipitate forms a gelatinous mass that readily clogs spray nozzles and is not commercially useful or acceptable. Therefore careful selection of the polyarcylamide component is important for successful compatibility of various spray tank mixes.

### SUMMARY OF THE INVENTION

The present disclosure includes a composition including: a salt of a monocarboxylic acid; and a polymer that hydrates in the presence of said salt and wherein the composition is stable at low temperatures. The polymer of the composition of the present disclosure is preferably compatible and stable with formulations of potassium glyphosate and used in a spray mixture. The composition may also contain formulation components such a defoamers, water conditioners, surfactants, biocides, stickers and solvents.

The composition preferably includes a polymer with an anionic charge such as polyacrylamide, wherein the charge of the polymer which is <50, <40, <30, <20, <15 and preferably <10 or may be any number or within any range between 50 and 10, 40 and 10; 30 and 10; or, 20 and 10 or any subrange therebetween.

A composition according the present disclosure includes a salt of a monocarboxylic acid, and a polyacrylamide polymer that hydrates at a pH of at least approximately 6 in the presence of no more than approximately 40 wt % of the salt. Most preferably, the present disclosure includes a salt of a monocarboxylic acid, and a polyacrylamide polymer that hydrates at a pH between at least approximately 6 and approximately 8 in the presence of less than or equal to approximately 30 wt % of the salt of a monocarboxylic acid. The polymer is preferably compatible and stable with formulations of potassium glyphosate used in a spray mixture.

The present disclosure also includes a method for producing a homogeneous composition for agrichemical use including the following steps. Obtaining a salt of a monocarboxylic acid. Obtaining a polyacrylamide polymer that hydrolyzes in the presence of no more than 40wt % (or 30 wt %) of the salt of a monocarboxylic acid at a pH of at least about 6. Combining the polyacrylamide and the monocarboxylic acid salt to produce the homogeneous composition. The method may also include combining the homogeneous composition with formulations of potassium glyphosate used in a spray mixture.

The pH of the composition of the present disclosure may be approximately 10, <10, 9, <9, 8, <8, 7, <7; 6, <6, >6, and preferably approximately 6 or any range between 10 and 6; 10 and 8; 10 and 7; 8 and 7; 8 and 6; 7 and 6 or any subrange therebetween.

The composition of the present disclosure may be added to a pesticide spray mixture to reduce driftable fine particles. The composition may be added to a pesticide spray mixture to reduce volatility of auxinic herbicides, including but not limited to dicamba and 2,4 d salts or acids. This composition may include adding potassium glyphosate to form spray mixtures. Alternatively, the composition may be added to tank mixtures containing isopropyl ammonium, monoethanolamine, diethanolamine and dimethylamne salts of glyphosate.

The foregoing has outlined in broad terms the more important features of the invention disclosed herein so that the detailed description that follows may be more clearly understood, and so that the contribution of the instant inventors to the art may be better appreciated. The instant invention is not limited in its application to the details of the construction and to the arrangements of the components set forth in the following description or illustrated in the drawings. Rather the invention is capable of other embodiments and of being practiced and carried out in various other ways not specifically enumerated herein. Additionally, the disclosure that follows is intended to apply to all alternatives, modifications and equivalents as may be included within the spirit and the scope of the invention as defined by the appended claims. Further, it should be understood that the phraseology and terminology employed herein are for the purpose of description and should not be regarded as limiting, unless the specification specifically so limits the invention.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processes and manufacturing techniques are omitted so as to not unnecessarily obscure the embodiments herein. The examples used herein are intended merely to facilitate an understanding of ways in which the invention herein may be practiced and to further enable those of skill in the art to practice the embodiments herein. Accordingly, the examples should not be construed as limiting the scope of the claimed invention.

The current invention is a homogeneous single phase of a polymer combined with a salt of a monocarboxylic acid, thereby combining the feature of drift control and vapor reduction of a pesticide spray.

The polymer for this combination must have low to very low anionic charge density, less than 50, less than 40, less than 30, less than 20 preferably less than 15% and even more preferred under 10%. Low anionic charge polymers are often referred to as “nonionic”

In practice polyacrylamides are supplied by the manufacturer as a dry, free flowing powder. In one method of this invention, the polyacrylamide powder is hydrated in water to which the salt of the monocarboxylic acid is added during or after hydration but most preferably during hydration. In a second method a dry formulation of polyacrylamide powder and dry salt of monocarboxylic acid are blended together for use by addition to water in a spray tank.

The salt of the monocarboxylic acid also has an impact on the polymer. Potassium salts reduce the speed of hydration of all types of polyacrylamides (independent of anionic charge) in a concentration dependent manner.

Example 1: Effect of potassium acetate concentration on polymer hydration.

Two separate polymers were tested for hydration in various wt percentages of an exemplary salt of a monocarboxylic acid. For these examples, potassium acetate was selected at three different concentrations, 30%, 40%, and 50%. These concentrations can be achieved by dilution of potassium acetate powder in water to the target concentration, however, for the present examples, a commercially available 50% potassium acetate solution was obtained which was diluted with water to adjust to the other target concentrations (40% and 30%). A 0% (water only) control was also employed.

Two exemplary commercially available polymers were selected for these examples, Pamamer 29 and Magnafloc 351. The polymers were tested separately with each different potassium acetate concentration and the control. In these examples, Pamamer 29 (1.3%) and Magnafloc 351 (1.1%) were added separately to each separate concentration of potassium acetate at room temperature (approximately 20° C. to 25° C.). For this example, the pH was adjusted to approximately 8, if necessary, by addition of a 50% citric acid solution.

Each separate combination was mixed using a Cowles disperser/dissolver/dispersater for a minimum of eight (8) hours. Following mixing, hydration was observed visually where a clear solution indicated hydration and a suspension of polymer (visually observable fish eyes) indicated a lack of hydration. Both polymers hydrated in the control. The observed effect of potassium acetate concentration on polymer hydration is set forth in Table 1. It is apparent that both polymers will hydrate at concentrations of salt of monocarboxylic acid of less than about 40% and particularly at any concentration less than or equal to about 30%.

TABLE 1
Effect of potassium acetate concentration on polymer hydration

| | | | Compatibility | Hydration | Hydration | Hydration |
|---|---|---|---|---|---|---|
| | | | with | in 50% | in 40% | in 30% |
| | | Mol | potassium | potassium | potassium | potassium |
| Polymer | Charge | weight | glyphosate | acetate | acetate | acetate |
| Pamamer 29 | Nonionic | Low | Compatible | No | Slightly | Yes |
| Magnafloc 351 | Nonionic | high | Compatible | No | No | Yes |

Example 2: Effect of pH on polymer stability in solution at low temperatures in 30% potassium acetate

Temperature and pH of the polymer can also affect both hydration and physical stability of the resulting solution.

For these examples, the two polymers were tested separately with a potassium acetate concentration of approximately 30%. In these examples, Pamamer 29 (1.3%) and Magnafloc 351 (1.1%) were each added to two separate 30% solutions of potassium acetate at room temperature (approximately 20° C. to 25° C.). The pH of one pair of polymer/salt solutions was adjusted to approximately 6 and the pH of the second pair of polymer/salt solutions was adjusted to approximately 8 by addition of a 50% citric acid solution.

Each separate combinations were mixed using a Cowles disperser/dissolver/dispersater for a minimum of eight (8) hours. Following mixing, hydration was observed visually where a clear solution indicated hydration and a suspension of polymer (visually observable fish eyes) indicated a lack of hydration. Each separate combination which exhibited hydration was then refrigerated to approximately 4° C. for thirty (30) days. After thirty days the temperature response was visually observed. A negative temperature response was indicated by the presence of gelling of the solution while a positive temperature response was indicated by a clear solution with a lack of or very little gel formation. The effect of pH on polymer stability in solution at low temperatures in 30% salt of monocarboxylic acid is indicated in Table 2.

TABLE 2
Effect of pH on polymer stability in solution
at low temperatures in 30% potassium acetate

| | | Mol | | Temperature | | Temperature |
|---|---|---|---|---|---|---|
| Polymer | Charge | weight | pH | Response | pH | response |
| Pamamer 29 | nonionic | low | 6 - hydrates | 4 C. no gel | 8 - hydrates | 4 C. gels |
| Magnafloc 351 | nonionic | high | 6 - will not | — | 8 -hydrates | 4 C. gels |
| | | | hydrate | | | |

The current disclosure provides a composition and method to produce stable homogeneous combinations of a nonionic (eg very low anionic charge) polyacrylamide and a salt of a monocarboxylic acid that are compatible with commonly used combinations of an auxin herbicide and/or potassium glyphosate, and effectively reduce driftable fines while suppressing volatility for auxin herbicides.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

### * * * *

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the spirit of this invention as defined by the appended claims.

What is claimed is:

1. A composition, comprising:
a salt of a monocarboxylic acid, and a polyacrylamide polymer that hydrates at a pH of at least approximately 6 in the presence of no more than approximately 40 wt % said salt.

2. A composition of claim 1 where said polymer is compatible and stable with formulations of potassium glyphosate used in a spray mixture.

3. A composition of claim 1 also containing formulation components selected from a group consisting of defoamers, water conditioners, surfactants, biocides, stickers and solvents.

4. The composition of claim 1 wherein the anionic charge of the polyacrylamide polymer is less than approximately 10.

5. The composition of claim 1 wherein the anionic charge of the polyacrylamide polymer is less than approximately 50.

6. The composition of claim 1 wherein the pH is less than approximately 10. The composition of claim 1 wherein the pH is less than approximately 8.

8. The composition of claim 1 wherein the pH is approximately 8.

9. The composition of claim 1 wherein the concentration of said salt of am monocarboxylic acid is no more than approximately 30 wt %.

10. The composition of claim 1 which is adapted so as not to form a gel at temperatures of approximately 4° C. and above.

11. A method of producing a homogeneous composition for agrichemical use, comprising:
obtaining a salt of a monocarboxylic acid;
obtaining a polyacrylamide polymer that hydrolyzes in the presence of no more than 40wt % of said salt of a monocarboxylic acid at a pH of at least about 6;
combining said polyacrylamide and said monocarboxylic acid salt to produce the homogeneous composition.

12. The method of claim 11 including adding said composition to formulations of potassium glyphosate for use in a spray mixture.

13. The method of claim 11 including adding one or more of a group consisting of defoamer, water conditioner, surfactant, biocide, sticker, solvent or a combination thereof.

14. The method of claim 11 wherein the anionic charge of the polyacrylamide polymer is less than approximately 10.

15. The composition of claim 11 wherein the anionic charge of the polyacrylamide polymer is less than approximately 50.

16. The composition of claim 11 wherein the pH is less than or equal to approximately 8.

17. The method of claim 11 including adding the homogeneous composition to a pesticide spray mixture to reduce driftable fine particles.

18. The method of claim 11 including adding the homogeneous composition to a pesticide spray mixture including auxinic herbicide in order to reduce volatility of said auxinic herbicide.

19. The method of claim 11 including adding the homogeneous composition to a spray mixture containing dicamba.

20. The method of claim 12 including the further step of adding the composition to tank mixtures containing isopropyl ammonium, monoethanolamine, diethanolamine and dimethylamne salts of glyphosate.
